(19) United States
(12) Patent Application Publication
(10) Pub. No.: US 2026/0228759 A1
(43) Pub. Date: Aug. 6, 2026

(54) MANAGEMENT OF ENTITY ACTIVITY

(71) Applicant: DevRev, Inc., Palo Alto, CA (US)

(72) Inventors: Mohan Maturi, San Jose, CA (US); Shruthi Racha, Redwood City, CA (US); Anmol Gupta, Bangalore (IN)

(73) Assignee: DevRev, Inc., Palo Alto, CA (US)

(21) Appl. No.: 19/046,392

(22) Filed: Feb. 5, 2025

(51) Int. Cl. G06Q 30/0201

(52) U.S. Cl. CPC G06Q 30/0201

(57) ABSTRACT

Techniques for managing entity activity across interactive portals are disclosed. The techniques include assigning a unique identifier to a request for accessing an interactive portal, capturing events and recording attributes indicating contextual data about interactions. An entity identifier is associated with the unique identifier upon registration. The attributes and data linked to the entity identifier are then analyzed to generate metrics and to create a representation of the entity's interactions and engagement patterns. The techniques enable tracking activity across multiple devices by associating multiple unique identifiers with the same user identifier. It performs retroactive deanonymization to determine complete historical entity journeys. The comprehensive approach to entity activity management provides valuable insights into user behavior, enables personalized experiences, and supports data-driven decision making for organizations across various digital platforms.

### TECHNICAL FIELD

The subject matter of the present invention relates to the management of activity associated with an entity. The subject matter described herein, in general, relates to monitoring and evaluation of activity associated with the entity across multiple devices and platforms.

### BACKGROUND

Entity activity monitoring and web analytics systems are essential tools in the digital landscape, enabling organizations to gain valuable insight into the behavior and engagement patterns of an entity. Entity activity monitoring and web analytics systems typically collect, process, and analyze data generated by entities as they interact with websites, applications, and online platforms. In an example, various tracking mechanisms may be employed to capture a wide range of entity actions, including page views, clicks, time spent on pages, and conversion events. Web analytics systems provide organizations with crucial insights about their online presence, helping them to understand entity preferences, optimize content, and improve overall entity experience. The insights drive data-informed decision-making in areas such as marketing strategy, product development, and customer service.

### BRIEF DESCRIPTION OF DRAWINGS

A detailed description is provided with reference to the accompanying figures. In the figures, the left-most digit(s) of a reference number identifies the figure in which the reference number first appears. The same numbers are used throughout the drawings to reference features and components.

FIG. 1 illustrates a system for management of entity activity, in accordance with an example of the present subject matter;

FIG. 2 illustrates a system for management of entity activity, in accordance with another example of the present subject matter;

FIG. 3 illustrates a block diagram of a computing system suitable for implementing an embodiment of the present subject matter.

FIG. 4 illustrates a block diagram of a method for management of entity activity, in accordance with an example implementation of the present subject matter;

FIG. 5 illustrates a non-transitory computer-readable medium for management of entity activity, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

In modern connected computing environments, an entity may interact with multiple interactive portals, such as a website or an application, for different purposes. Entities, for example, users, databases, software applications, platforms, servers, client devices, computing systems, and other resources or devices may interact with multiple interactive portals for different purposes and to perform different tasks. Such interactions may be frequent and integral for various operations or workflows. For example, user activity monitoring and web analytics systems may monitor and evaluate the interactions of the user with websites and applications to gain insights into the behavior and engagement patterns of the user.

However, such monitoring and evaluation of the interactions of the user with various interactive portals may experience several challenges. Conventional user activity management systems typically rely on a combination of client-side and server-side technologies to collect, process, and analyze data about users, such as website visitors, and their interactions. Conventionally, a tracking code is embedded in websites or applications to collect data on user interactions to provides insights on user behavior and engagement patterns. For example, the tracking code may capture information, such as page views, clicks, form submissions, and custom events. However, the conventional techniques have several limitations that may hinder their effectiveness in providing comprehensive and actionable insights.

The conventional user activity management systems generally rely on identifiers, such as browser cookies to identify users. While the browser cookies may help in tracking a user within a single browser on a single device, it may be ineffective in accurately identifying and tracking the user when the user switches device or clears their cookies. Such an approach may lead to a fragmented view of user behavior, where a single user may be counted as multiple unique users. Consequently, the result may often lead to inflated user counts and an incomplete understanding of the user's behavior pattern or user journey. The problem may be exacerbated by the increasing prevalence of multi-device usage, where a single user may interact with a website or application on their desktop computer, smartphone, and tablet at different time periods. Thus, such fragmentation of user identity across various devices may pose a significant challenge in evaluating and tracking user behavior holistically.

Further, the conventional techniques may not retroactively associate previous anonymous activity with a newly identified user (e.g., by logging in or making a purchase). In such scenarios, the valuable information about a user's behavior prior to identification is often lost or remains disconnected from their known profile. The difficulty in connecting anonymous website visitors to known users once they identify themselves may prove to be a significant obstacle. For example, the gap in data, before and after the user identification, may be a significant obstacle for organizations trying to understand the complete user journey, i.e., from initial awareness to conversion.

In conventional user activity management systems, the data associated with user activity is aggregated at the collection time, thereby discarding or limiting access to raw and event-level data. Though such an approach may help in managing data volume, it significantly limits the ability to perform deep, custom analyses or to revisit historical data with new queries or perspectives. Such techniques may be inefficient for organizations with evolving analytics needs, as they may be unable to extract new insights from old data without setting up new tracking parameters in advance.

The challenge is further aggravated in accurately attributing user actions and conversions to specific marketing campaigns. Conventional techniques typically rely on last-click attribution, which fails to account for the complex, multi-touch nature of user's journey. This may lead to misallocation of marketing resources and suboptimal campaign strategies. In addition, conventional systems have limitations on how long they retain the data associated with the entities, which may make long-term trend analysis burdensome and erroneous. Thus, the conventional approaches have various challenges in terms of providing comprehensive history of user interactions over time, data ownership, customization options, and the ability to track users across various devices.

The present subject matter envisages techniques for managing entity activity. The entity activity may be referred to as the activity associated with an entity, such as a user, a database, a software application, a platform, a server, a client device, a computing system, and other resource or device. According to one example, a user may access an interactive portal, such as a website or an application, through an interactive platform like a web browser or mobile application. Upon receiving the access request, a unique identifier may be assigned to the request. In an example, the unique identifier may be a unique token intrinsically linked to a specific device being used by the user (e.g., a smartphone, tablet, or computer), the interactive platform (e.g., Chrome browser, Safari, or a mobile application) through which the access is occurring, or both.

Once the unique identifier is assigned, an event tracker may capture an event for the interactive portal accessed by the user. The event tracker may be operationally integrated with the interactive platform and may be designed to capture various events that occur during the user's interaction with the interactive portal. In an example, the event tracker may be embedded with the interactive platform. An event, in this context, refers to any significant action or occurrence that may provide insight into the user's behavior or engagement. For instance, the event may include page views, button clicks, form submissions, video plays, or any other interaction that may be relevant for analysis of user's behavior.

For each event captured, a set of attributes may be recorded. In an example, the set of attributes may serve as contextual metadata, providing information about the circumstances and nature of the event. The attributes may include, but are not limited to timestamp of the event, type of event (e.g., page view, click, form submission), specific element interacted with (e.g., a particular button or form field), duration of interaction, user's geographic location, device type and specifications, interactive platform version, screen resolution, and operating system. In another example, the set of attributes may serve as contextual data related to the interactive portal itself. The attributes may include the full Uniform Resource Locator (URL) of the page being accessed, Urchin Tracking Module (UTM) parameters present in the URL providing information about the marketing campaign that led the user to the interactive portal, referrer information indicating the previous page or site the user came from, any search queries that led to the visit of the interactive portal visit, and A/B testing variants the user is exposed to, and user preferences or settings within the interactive portal.

In an example, the set of attributes may include contextual data indicating one or more aspects related to at least one of the event and the interactive portal. The contextual data collection allows for a holistic understanding of the action users are taking and the context in which the actions are occurring. Such a level of detail may be of vital importance for marketers, product managers, and analysts seeking to optimize user experience and marketing strategies.

In one example implementation, the present subject matter allows for a seamless transition from an anonymous user tracking to identified user tracking. In an example, when a user decides to register or log in to the interactive portal, the previously anonymous unique identifier may be associated with the user's actual identity, referred to as an entity identifier or a user identifier. For instance, the user identifier may be represented by an email address or username. This process, often referred to as identity resolution, may allow in maintaining a continuous and comprehensive view of a user's journey, from their very first anonymous interaction to their latest authenticated session.

Once the set of attributes is recorded and the unique identifier is linked with the user identifier, the set of attributes and the data linked with the user identifier are analyzed. In an example implementation, the captured attributes and the data linked with the entity identifier (user's identity) are analyzed to generate a set of meaningful metrics. The metrics may serve as indicators of various aspects of user behavior, engagement, and the effectiveness of different parts of the interactive portal. In an example, the metrics may comprise session-level metrics including session duration, number of pages or screens viewed per session, average time spent per page or screen, entry and exit points, and bounce rate. In an example, the metrics may comprise user-level metrics including total number of sessions, cumulative time spent on the interactive portal, frequency of visits, time between visits, conversion rates for key actions (e.g., sign-ups, purchases), and feature adoption rates.

In another example, the metrics may comprise content engagement metrics including most viewed pages or content pieces, time spent on different types of content, scroll depth on long-form content, and video play rates and drop-off points. In an example, the metrics may comprise campaign and acquisition metrics including traffic sources, campaign performance (based on UTM parameters), and conversion rates by traffic source or campaign. In an example, the metrics may comprise technical performance metrics including page load times, error rates, and device and browser usage statistics. In yet another example, the metrics may comprise organization-level metrics including number of active users from each organization, cumulative engagement time per organization, and feature adoption rates at the organizational level. In an example implementation, the set of metrics may include one or more of session-level metrics, user-level metrics, content engagement metrics, campaign and acquisition metrics, technical performance metrics, and organization-level metrics.

Based on the metrics, the representation of the user may be generated. The representation may be indicative of interactions and engagement patterns of the user with the interactive portal. In an example, the representation may include user's journey map indicating visual representation of a user's path through the interactive portal over time, highlighting key interactions and decision points. In another example, the representation may include engagement scores indicating numerical or categorical ratings that summarize a user's overall level of engagement with the interactive portal. The representation may also include segmentation profiles indicating groupings of users based on similar behavior patterns, preferences, or characteristics. Additionally, the representation may include predictive indicators indicating scores or flags suggesting a user's likelihood of taking certain actions (e.g., likelihood to convert, churn risk) and interest and preference profiles summarizing the types of content or features a user engages with most frequently.

The present subject matter offers several significant advantages in management of the activity associated with the entity across multiple devices and platforms. An important aspect of the present subject matter is its ability to transition from anonymous tracking to identified user tracking. When a user decides to register an account on the interactive platform, by providing their email address or username, the new user identifier gets associated with the previously assigned unique identifier. The association of the user identifier with the unique identifier allows to connect all prior anonymous activity with the now-identified user, creating a complete picture of the user journey.

By assigning unique anonymous identifiers to users and leveraging the event tracker, the present subject matter enables comprehensive tracking of user interactions across multiple devices and sessions. Such a cross-device tracking capability provides a holistic view of user engagement, allowing organizations to better understand how users interact with their digital properties across various platforms. Further, the integration of the user identifier, such as email addresses, upon user sign-up further enhances this functionality, creating a unified profile that connects all user's activities, regardless of the device or interactive platform used. The comprehensive user profile enables more accurate targeting and personalization of marketing efforts, potentially leading to improved conversion rates and user satisfaction.

The present subject matter's ability to capture the event and one or more attributes for the event, including page views, URL visits, campaign data, and user IP addresses, provides a comprehensive dataset for analysis. Such a granular level of data collection allows for in-depth insights into user behavior, preferences, and patterns. By performing analysis on the collected data, the present subject matter may generate valuable metrics that inform decision-making across various organization functions. The metrics encompass crucial information such as session analytics, including duration and page visits, which can help organizations to optimize their website structure and content to improve user engagement. The analysis of user behavior across multiple devices may further enhance the understanding, allowing organizations to tailor their digital experiences to suit different device types and usage patterns.

Additionally, based on generated metrics, the present subject matter creates a comprehensive representation of each user. The representation serves as a detailed profile of the user's interactions and engagement patterns, allowing platform owners to understand how users navigate their site, what content they find most engaging, and how their behavior changes over time. Thus, the present technique provides a holistic view of user behavior, from the first anonymous visit to becoming a registered user and beyond. By combining anonymous tracking with identified user data, the present subject matter bridges the gap between initial interest and long-term engagement of the user, thereby providing valuable insights throughout the user lifecycle. The technique may also enable organizations to track the effectiveness of their marketing campaigns, identify areas of their platform that are most engaging or problematic, and tailor their offerings to better meet user needs.

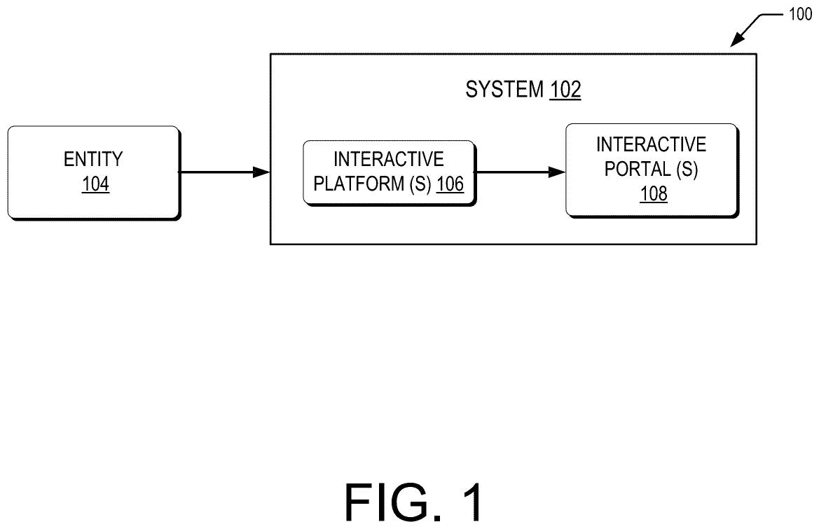

The present subject matter is further described with reference to FIGS. 1-5. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 102 for management of entity activity, according to an example implementation of the present subject matter. The system 102 may be implemented in various computing environments 100 and contexts. In an example, the system 102 may be deployed on cloud-based infrastructure, allowing for scalability and flexibility in resource allocation. The system 102 may also be implemented on on-premises servers or as a hybrid solution combining both cloud and on-premises components. In some cases, organizations may choose to implement the system 102 as a Software-as-a-Service (SaaS) solution, enabling easy access and reducing the need for in-house infrastructure management. Alternatively, larger organizations may opt for a fully customized, on-premises deployment to maintain complete control over their data and security protocols.

The system 102 may be communicatively coupled to one or more entity 104 through a network infrastructure. The one or more entity may be users, databases, software applications, platforms, servers, client devices, computing systems, and other resources or devices. In an example, the network infrastructure may include local area networks (LANs), wide area networks (WANs), cloud-based networks, or hybrid network configurations, enabling seamless communication and data transfer between the system 102 and its connected components. The system 102 may communicate with the entity 104 through various communication protocols and interfaces, such as APIs, web services, database connectors, or secure file transfer protocols. The system 102 may also be communicatively coupled to a data repository (not shown) for storing the data associated with user interaction with the interactive portal and the user identifiers. The data repository, housing vast amounts of raw data, may be used for the tracking and analysis operations to extract meaningful insights.

In an example, the entity 104 may access an interactive portal 108 through an interactive platform 106. The interactive platform 106 may include various software interfaces or applications that may enable entities to interact with digital content and services. Examples of interactive platforms include web browsers (such as Google Chrome, Mozilla Firefox, or Safari), mobile applications, desktop software, and specialized client applications. For instance, the interactive platform 106 may encompass a web browser rendering HTML content, a mobile app providing a tailored user interface for smartphone users, or a desktop application offering functionality for users. The interactive platform 106 may serve as the primary point of interaction between the entity and the interactive portal, generating user events, capturing user inputs, and displaying responses from the system.

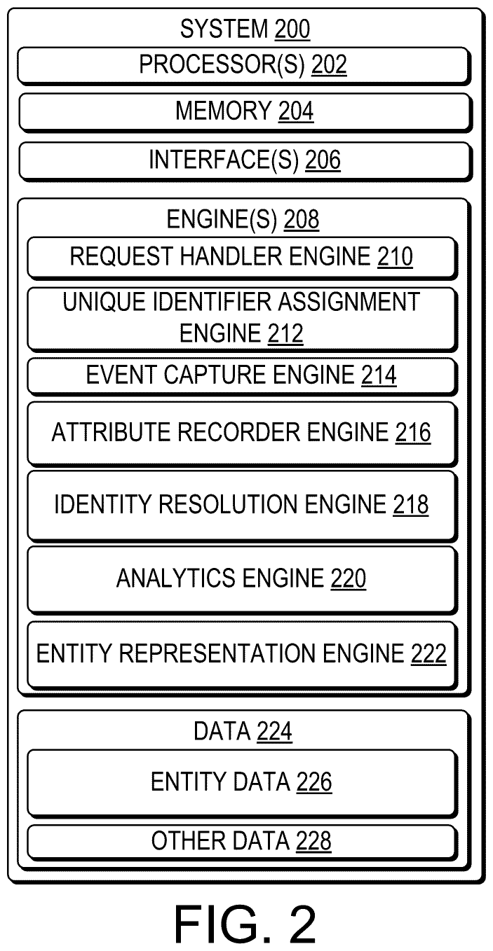

In an example implementation, an interactive portal 108 may include websites, web applications, or mobile applications designed to facilitate user engagement and data collection. The interactive portal 108 represents the digital interface through which entities interact with an organization's online presence, services, or products. The interactive portal 108 may be chosen based on the organization's specific needs, such as data analysis requirements, operational processes, or integration with other systems. For instance, an interactive portal 108 may be an e-commerce website, a customer support platform, a content management system, or a business intelligence dashboard. The system 102 manages the entity activity data generated through interactions with these portals, including capturing events, recording attributes, and analyzing user behavior patterns, as explained in detail with respect to FIG. 2.

FIG. 2 illustrates a system 200 for management of entity activity, according to an example implementation of the present subject matter. The system 200 may include a computing device that has processing capabilities, such as a server, a desktop, a laptop, a tablet, a mobile phone, or the like. For instance, the system 200 may include, for example, a microprocessor, a microcomputer, a microcontroller, a digital signal processor, a central processing unit, a state machine, a logic circuitry, or a device that manipulates signals based on operational instructions. The system 200 may correspond to the system 102. The system 200 may include a processor 202, a memory 204, and an interface(s) 206.

The processor 202 may run at least one operating system and other applications and services. Further, the processor 202 can include one or more engines 208. The processor 202, amongst other capabilities, may be configured to fetch and execute computer-readable instructions stored in the memory 204. The processor 202 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processor”, may be provided through the use of dedicated hardware as well as hardware capable of executing machine readable instructions.

When provided by the processor 202, the functions may be provided by a single dedicated processor, by a single shared processor, or by a plurality of individual processors, some of which may be shared. Moreover, explicit use of the term “processor” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The memory 204 may be coupled to the processor 202 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 204 may include data 224, such as an entity data 226 and other data 228, that can be commissioned for management of entity activity.

The interface(s) 206 may include a variety of machine-readable instructions-based interfaces and hardware interfaces that allow the system 200 to interact with different entities, such as the processor 202 and the memory 204. Further, the interface may enable the components of the system 200 to communicate with computing devices, web servers, and external repositories. The interface may facilitate multiple communications within a wide variety of networks and protocol types, including wireless networks, wireless Local Area Network (WLAN), RAN, satellite-based network, and the like.

The engines 208 may include routines, programs, objects, components, data structures, and the like, which perform particular tasks or implement particular abstract data types. The engines 208 may further include modules that supplement applications on the system 200, for example, modules of an operating system. Further, the engines 208 may be implemented in hardware, instructions executed by a processor, or by a combination thereof.

In an implementation, the engines 208 may be machine-readable instructions which, when executed by the processor 202, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engine 208 may perform different functionalities. The engines 208 include a request handler engine 210, an unique identifier assignment engine 212, an event capture engine 214, an attribute recorder engine 216, an identity resolution engine 218, an analytics engine 220, and an entity representation engine 222. The functions of the engines 210, 212, 214, 216, 218, 220, 222 are explained below.

In an example, the request handler engine 210 may receive a request from an entity to access an interactive portal through an interactive platform. In an example implementation, the entity, such as a user may access the interactive portal, such as a website or a web application, through the interactive platform, such as a web browser or a mobile application. For instance, the request may be a user clicking on a link to access a company's website, opening a mobile application to view an e-commerce platform, or entering a URL in a web browser to visit a social media site. The request may also be an API call from a software application seeking to interact with a web service, or an automated script initiating a connection to a data analytics dashboard. In the context of entity activity management, the requests may serve as the initial touchpoints for tracking and analyzing user interactions across various digital platforms.

Upon receiving the request, the unique identifier assignment engine 212 may initiate the process of assigning a unique identifier to the request. The unique identifier may serve as a digital fingerprint for that particular user session, allowing the system to recognize and track the user's activities throughout their interaction with the interactive portal. In one example, the unique identifier may be a string of alphanumeric characters, generated using algorithms to ensure its uniqueness across all users and sessions. The unique identifier may be designed to be anonymous, i.e., not including any personally identifiable information about the user. The unique identifier may serve as a reference point to which all subsequent user actions may be linked.

In an example implementation, the process of assigning the unique identifier is automated and is initiated in real-time, as soon as the request is received from the entity. Such a process ensures that no user actions are missed, and the tracking begins from the very first interaction of the user with the interactive portal. In an example, the system 200 may receive high volumes of simultaneous requests and the unique identifier assignment engine 212 may assign unique identifiers to each request without delay or conflict.

The assigned unique identifier is linked with both the device and the interactive platform used to access the interactive portal. Such a linkage may provide valuable context to the user's interactions. For instance, by associating the unique identifier with the specific device, the system 200 may differentiate between users accessing the interactive portal from different devices, such as a desktop computer, a smartphone, or a tablet. For instance, if a user accesses the platform from his smartphone, the user may be assigned a unique identifier “MOBILE_USER_12345,” while the same user accessing the platform from his laptop may be assigned a unique identifier “DESKTOP_USER_67890.” The device-specific tracking approach may allow for more granular analysis of user behavior across different devices. Similarly, linking the unique identifier with the interactive platform, such as Chrome browser, Safari, Firefox, or a specific mobile app, may provide additional layers of context. Different platforms may offer different user experiences or functionalities, and tracking these distinctions can offer insights into how users interact with the interactive portal across various interfaces.

In an example, the unique identifier may be stored in a local storage associated with the user's device. For instance, the storage of the unique identifier in the local storage may be implemented through various techniques, such as browser cookies, local storage APIs, or device-specific storage mechanisms. By storing the identifier locally, the system ensures that it can recognize the same user (or at least the same device) upon subsequent visits, even if they haven't explicitly logged in or created an account. In an example, the association of the unique identifier with the device and the interactive platform may be stored in the data 224, creating a new entry linking the unique identifier with the device and the interactive platform information.

In an example, the association of the unique identifier with the device and the interactive platform used to access the portal may help the system 200 to recognize the same user across multiple sessions, if they are using the same device and the same interactive platform. However, if a user switches to a different device or uses a different browser on the same device, a new unique identifier would be assigned. Such a limitation may be addressed by the system 200 through user registration and email-based identification.

In an example implementation, the event capture engine 214 may capture an event for the interactive portal being accessed by the entity. The event may be captured when the entity, typically a user, interacts with the interactive portal through the interactive platform. In an example, the event may be captured by utilizing an event tracker. The event tracker may be a specialized tool or an element of software designed to monitor and record user interactions with the interactive portal. The event tracker is operationally linked with the interactive platform. For instance, the event tracker may be integrated into the interactive platform or closely connected with the interactive platform's functionality. The linkage of the event tracker may allow the event tracker to observe and record occurrence of user actions in real-time within the interactive portal. The operational linkage ensures that the event tracker has access to all necessary data and can function seamlessly without disrupting the user experience.

When the entity accesses the interactive portal, the event tracker may begin monitoring the event interactions. In an example, the interactions may encompass a wide range of activities, such as page views, button clicks, form submissions, scroll depth, time spent on a page, or any other measurable action indicating engagement with the interactive portal's content or features. Each of the interactions may be referred to as an event in the context of the system 200.

In an example implementation, the attribute recorder engine 216 may record one or more attributes for each event. When a user interacts with the interactive portal, each action or event may trigger the recording of multiple attributes. The attributes serve as data points that, when analyzed collectively, may provide a comprehensive picture of the user's journey and experience. In an example, the attributes may include contextual data indicating one or more aspects related to the event, or the interactive portal, or both. The contextual data associated with the attributes offers additional layers of information, enriching the understanding of both the specific event and the broader context of the interactive portal.

In one example, the recorded attribute may be a timestamp of the event. The timestamp is essential for understanding the occurrence time of the interaction, allowing for chronological analysis of user behavior. The timestamp may also enable the system 200 to track the sequence of events, measure the duration between interactions, and identify patterns in user activity over time. For instance, the timestamp may reveal peak usage times, helping to optimize resource allocation and improve user experience during high-traffic periods.

In another example, the recorded attribute may be a specific action or an event type. The event type may include simple page views to more complex interactions like form submissions, button clicks, or file downloads. By categorizing the events into the event types, the system may differentiate between various types of engagement, providing insights into which features, or content are most popular or frequently used. Such information may help in understanding user preferences and optimizing the interactive portal's design and functionality.

The recorded attribute may also include a resource identifier, such as a specific location or a uniform resource locator (URL) within the interactive portal where the event occurred. The specific location helps in mapping the user's journey through the interactive portal, identifying which pages or sections are most visited, and which might be underutilized. The specific location may also reveal navigation patterns, helping to optimize the portal's structure and improve user flow. Additionally, by analyzing the sequence of URLs visited, the system 200 may identify common paths taken by users, thereby providing opportunities for streamlining the user experience or highlighting areas where users might be getting lost or frustrated.

Further, contextual data related to the user's device and browser may also be recorded as part of the event attributes. The contextual data may include information, such as the device type (desktop, mobile, tablet), operating system, browser type and version, and screen resolution. The contextual data may be crucial for ensuring compatibility and optimizing the interactive portal's performance across different platforms. It also helps in understanding how user behavior may vary depending on the device used, allowing for streamlined experiences across different platforms.

In an example, the recorded attribute may be a network identifier, such as user's geographic location. For instance, the network identifier may be an internet protocol (IP) address of the user's device at the time of the interaction. The network identifier may provide valuable information about the user's general location and network environment. This information may be used to analyze regional trends, streamline content or offerings based on location, and ensure compliance with region-specific regulations. It also helps in understanding the global reach of the interactive portal and identifying potential areas for expansion or localization efforts. A source identifier, such as referral source information is another recorded attribute that may provide insight into how users are discovering and accessing the interactive portal. The referral source information may include search engines, social media platforms, email campaigns, or direct traffic. By tracking the referral sources, the system can evaluate the effectiveness of different marketing channels and campaigns, helping to optimize marketing strategies and allocate resources more effectively.

For events related to specific marketing campaigns, additional attributes such as Urchin Tracking Module (UTM) parameters may also be recorded. The UTM parameters may include campaign source, medium, name, content, and term. The detailed campaign tracking allows for precise measurement of marketing effectiveness, enabling the organization to attribute user actions and conversions to specific marketing efforts. The recorded attribute may also include user interaction details, such as mouse movements, scroll depth, time spent on page, and click patterns. Such granular data provides insights into user engagement levels and may help in identifying areas of the interactive portal that are particularly engaging or, conversely, where users may be experiencing difficulties or losing interest.

The attributes may also be session-related attributes, such as session duration, number of pages visited within a session, and whether it's a new or returning session. Analysis of the session data may help to understand the user engagement over time, identify patterns in repeat visits, and gauge the overall stickiness of the interactive portal. In an example, performance-related attributes may also be captured, including page load times, server response times, and any errors encountered during the interaction. The system may also record attributes related to the content being interacted with, such as content categories, tags, or other metadata associated with the pages or elements the user engages with. Analysis of this data can reveal trends in content popularity, help in content strategy decisions, and enable more effective personalization of content delivery. Thus, by capturing the multiple attributes and contextual data, the system provides a holistic view of each event and its relationship to the broader context of the interactive portal. Such detailed recording enables advanced analytics, personalization, and optimization strategies, thereby leading to improved user experience, more effective marketing, and better achievement of organization objectives.

The identity resolution engine 218 may then associate an entity identifier with the unique identifier upon entity registration. In an example, when a user first visits the website or application, they are assigned a unique anonymous identifier, for example, stored as a browser cookie. The unique identifier allows the system to track the user's activities across multiple pages and sessions while maintaining their privacy. However, at this stage, the system has no way of knowing the user's actual identity or connecting their activities to a specific individual or organization. The association of the entity identifier with the unique identifier occurs when the user takes an action that reveals their identity, for example through the process of registration or signing up for an account. During the registration process, the user may provide identifying information such as their email address, name, or other relevant details. The identifying information may be referred to as the entity identifier, a piece of data that uniquely identifies the individual user or, in some scenarios, the organization they represent.

Upon successful registration, the identity resolution engine 218 may link the previously anonymous unique identifier with the newly acquired entity identifier. Such linkage may be stored in a database or data warehouse or data repository, creating a permanent association between the user's anonymous browsing history and their identified account. This process effectively “deanonymizes” the user's previous activities, allowing the system to attribute all past and future interactions to a known entity. Further, the association process is not limited to a single device or browser. If a user registers or logs in from multiple devices or browsers, each with its own unique anonymous identifier, the system can link these identifiers to the same entity identifier. This cross-device tracking capability thus provides a holistic view of the user's interactions across their entire digital ecosystem.

The association of the entity identifier with the unique identifier helps in performing retroactive analysis. Once the entity identifier is linked to the unique identifier, the system can look back at all previous interactions associated with that unique identifier and attribute them to the now-known user. Such retroactive attribution allows for a complete understanding of the user's historical journey, from their very first anonymous visit to their most recent authenticated interaction. The association also enables more sophisticated user segmentation and personalization strategies. With the ability to connect anonymous behavior to identified users, marketers and analysts may create more accurate user profiles, by taking into account both pre-and post-registration activities. Thus, the association allows for more targeted marketing campaigns, personalized content recommendations, and improved user experience optimizations.

In an example, the data associated with the attributes of each interaction and the associated user identifiers may be stored in a data repository. The data repository may help in the tracking and analysis operations, housing vast amounts of raw data that will later be processed to extract meaningful insights.

In an example implementation, the analytics engine 220 may analyze the one or more attributes and the data linked with the entity identifier. For instance, the analysis may begin with the collection and aggregation of various data points associated with each entity's interactions. The data points may include the attributes captured during each event, such as the resource identifier (URL), source identifier, network identifier (IP address), and any additional contextual data like campaign tracking parameters and referrer information. The entity identifier, which is linked to the unique anonymous ID upon registration, serves as a key to consolidate all historical and current data associated with a particular user.

Based on the analysis, the analytics engine 220 may construct a comprehensive user journey. This journey mapping may start from the very first interaction of the entity with the interactive portal, as an anonymous user, and may continue through their registration and subsequent engagements. By leveraging the capability to perform retroactive deanonymization, the system can attribute previously anonymous activities to the now-identified user, providing a complete historical view of their interactions.

In an example, the analytics engine 220 may analyze the one or more attributes and the data linked with the entity identifier to generate metrics. The metrics may include one or more of session analytics, user behavior analytics, and organizational analytics based on user identifiers. The session analytics may provide insights into individual user sessions. The session analytics may include measurements such as session duration (how long a user remains actively engaged with the platform in a single sitting) and element accesses (which parts of the platform the user interacted with and in what order). For instance, the system may determine that a particular user typically spends an average of 15 minutes per session and tends to visit the “New Arrivals” section before browsing specific product categories. The session analytics may also include number of pages visited per session, average time per page, entry and exit pages, and the depth of interaction within the interactive portal. In an example, a new session initiation may be determined after a predefined period of entity inactivity, and the session analytics may be generated. In such scenario, the session analytics may include session duration, number of interactive portal accessed, and time spent on each interactive portal within the session.

The user behavior analytics may aggregate data across multiple sessions for each unique entity. This allows for the generation of metrics that indicate long-term engagement patterns and user value. Such metrics might include total number of sessions, cumulative time spent on the site, frequency of visits, average session duration over time, and the total number of unique pages viewed. Additionally, user behavior analytics may reveal patterns in device usage, preferred content types, and responsiveness to different marketing campaigns. In addition, organizational analytics may segment users based on various criteria. By examining the entity identifier and associated data, the system can group users by characteristics such as their organizational domain, geographic location, or the marketing channel through which they were acquired. Such segmentation allows for the generation of cohort-specific metrics, enabling comparisons between different user groups and the identification of high-value segments.

The generated metrics may thus serve as indicators of various aspects of user behavior, engagement, and value and help in identifying trends, predicting future behaviors, optimizing marketing efforts, improving user experience, and ultimately driving organizational growth. Further, by combining and correlating different metrics, the system can exhibit complex patterns and relationships that might not be apparent when looking at single data points in isolation.

In an example implementation, the entity representation engine 222 may generate representation of the entity based on the metrics. In one example, to generate the representation, the entity representation engine 222 may aggregate and analyze the various metrics collected throughout the entity's interactions with the interactive platform. The metrics may encompass a wide range of data points, including but not limited to, session duration, frequency of visits, pages viewed, actions taken (such as downloads, form submissions, or purchases), time spent on specific pages, scroll depth, click-through rates, and engagement with interactive elements like videos or chatbots. The system may also consider the entity's journey across multiple devices, if applicable, by linking various anonymous IDs to a single entity identifier upon registration.

Once the raw data is collected, the system may employ advanced analytics algorithms to process and interpret this information. The algorithms may be designed to identify patterns, trends, and anomalies in the entity's behavior. For instance, the system may recognize that an entity consistently spends more time on product pages related to a specific category, indicating a strong interest in that area. Alternatively, the system may detect a pattern of increased activity during certain times of day or days of the week, suggesting optimal periods for engagement. The representation may also consider the entity's interaction history with marketing campaigns. By analyzing the UTM parameters and referrer information captured during each visit, the system may attribute the entity's activities to specific marketing efforts. This allows for a clear understanding of which campaigns or channels are most effective in driving engagement for this particular entity. Further, the representation may include a breakdown of the entity's interactions by campaign source, medium, and content, thereby providing a comprehensive view of their journey from initial awareness to current engagement level.

In an example, the system may associate multiple unique identifiers corresponding to multiple devices with a single user identifier. Subsequently, a consolidated representation of the user's interactions across the multiple devices may be generated. The consolidated view is a powerful tool for understanding the user's complete journey and engagement patterns. In one example, the process of generating the consolidated representation may include aggregating and analyzing data from all the user's associated devices. The data may include information such as page views, time spent on various sections of the website or application, interaction with specific features or content, purchase history, search queries, and any other relevant metrics that the platform tracks.

The consolidated representation may take various forms depending on the specific needs of the organizations and the nature of the platform. The consolidated representation may be a detailed timeline of the user's interactions across all devices, showing how they move between devices throughout their customer journey. For example, the representation may reveal that a user typically browses products on their smartphone during their commute, compares prices on their work computer during lunch breaks, and finalizes purchases from their tablet in the evening.

The present subject matter offers several significant advantages in managing entity activity across multiple devices and platforms. A key benefit is its ability to transition seamlessly from anonymous tracking to identified user tracking, creating a complete representation of the user journey from initial awareness to conversion. By assigning unique anonymous identifiers and leveraging an event tracker, the system enables comprehensive cross-device tracking, thereby providing a holistic view of user engagement across various platforms. This capability is further enhanced by integrating user identifiers upon sign-up, creating unified profiles that connect all user activities regardless of device or platform used. Further, the granular data collection, including detailed event attributes and contextual data, allows for in-depth insights into user behavior, preferences, and patterns. Furthermore, the comprehensive representation of each user may serve as a detailed profile of interactions and engagement patterns. The comprehensive approach to entity activity management leads to improved user experiences, more effective marketing strategies, and better achievement of organizational objectives.

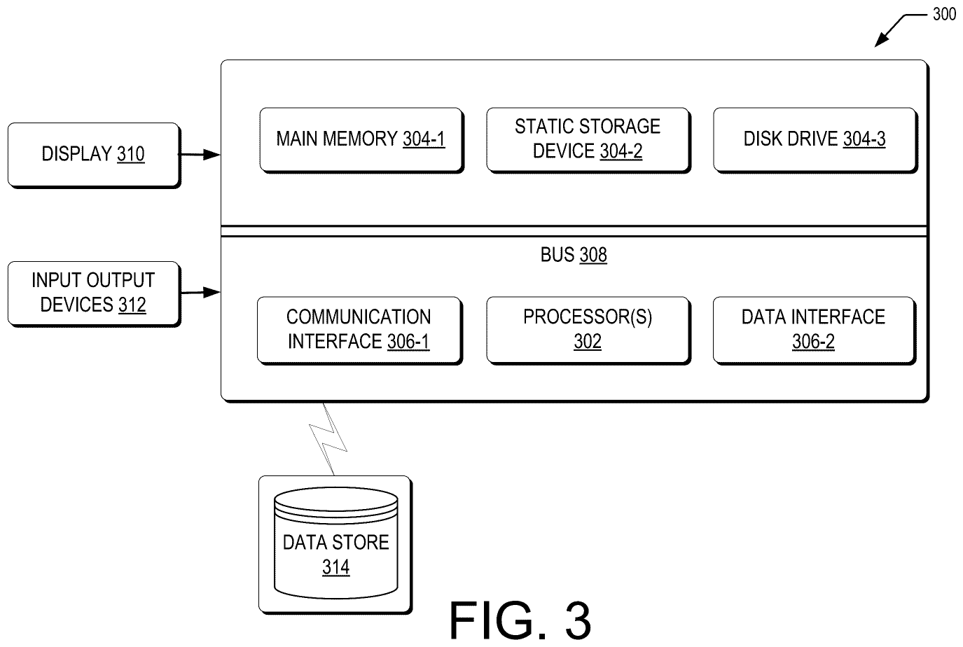

FIG. 3 illustrates a block diagram of a computing system 300 suitable for implementing an embodiment of the present subject matter. Computing system 300 may include a bus 308 or other communication mechanism for communicating information, which interconnects subsystems and devices, such as processor(s) 302, main memory 304-1 (e.g., RAM), static storage device 304-2 (e.g., ROM), disk drive 304-3 (e.g., magnetic or optical), communication interface 306-1 (e.g., modem or Ethernet card), display 310 (e.g., CRT or LCD), input device 312 (e.g., keyboard, and cursor control).

According to one embodiment of the present subject matter, the computing system 300 performs specific operations by the processor(s) 302 executing one or more sequences of one or more instructions contained in the main memory 304-1. Such instructions may be read into the main memory 304-1 from another computer readable/usable medium, such as the static storage device 304-2 or disk drive 304-3. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor(s) 302 for execution. Such a medium may take many forms, including but not limited to, non-volatile media and volatile media. Non-volatile media includes, for example, optical or magnetic disks, such as disk drive 304-3. Volatile media includes dynamic memory, such as main memory 304-1. A data store 314 may be accessed in a computer readable medium using a data interface 306-2.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 300. According to other embodiments of the present subject matter, two or more computing systems 300 coupled by communication link (e.g., LAN, PTSN, or wireless network) may perform the sequence of instructions required to practice the invention in coordination with one another.

The computing system 300 may transmit and receive messages, data, and instructions, including program, i.e., application code, through communication link and communication interface 306-1. Received program code may be executed by the processor(s) 302 as it is received, and/or stored in the disk drive 304-3, or other non-volatile storage for later execution.

In a typical configuration, the computer includes one or more processors (CPU), an input/output interface, a network interface, and a memory. The memory can consist of a non-persistent memory, a random-access memory (RAM), and/or a non-volatile memory in a computer-readable medium, for example, a read-only memory (ROM) or a flash memory (flash RAM). Memory is an example of a computer-readable medium.

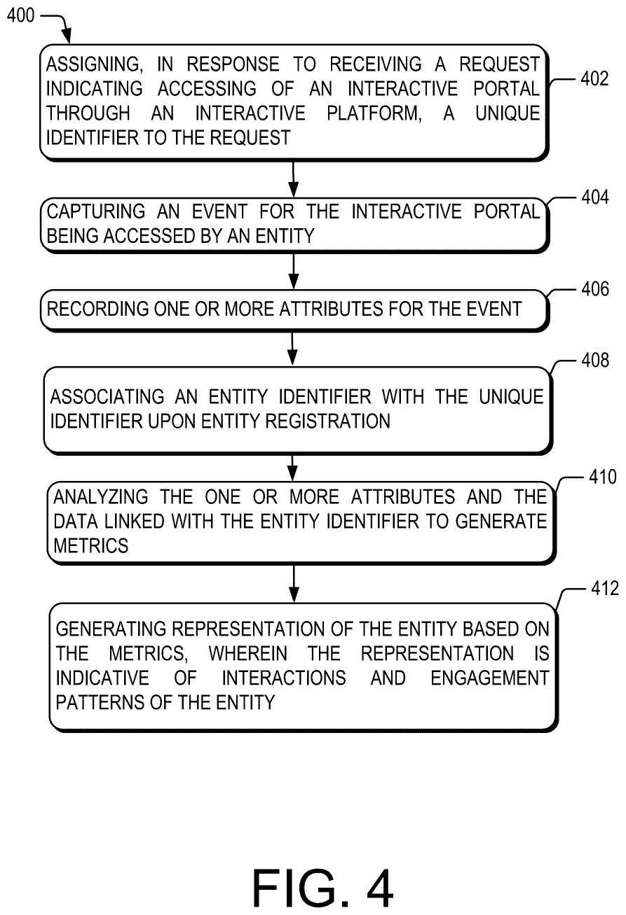

FIG. 4 illustrates a block diagram of a method for management of entity activity, in accordance with an example implementation of the present subject matter. Although the method 400 may be implemented in a variety of devices, but for the ease of explanation, the description of the method 400 is provided in reference to the above-described system 102 and 200. The order in which the method 400 is described is not intended to be construed as a limitation, and any number of the described method blocks may be combined in any order to implement the method 400, or an alternative method.

It may be understood that blocks of the method 400 may be performed in the system 102 and 200. The blocks of the method 400 may be executed based on instructions stored in a non-transitory computer-readable medium, as will be readily understood. The non-transitory computer-readable medium may comprise, for example, digital memories, magnetic storage media, such as magnetic disks and magnetic tapes, hard drives, or optically readable digital data storage media.

At block 402, the method includes assigning a unique identifier in response to receiving a request from an entity. In an example, the entity may be a user, a database, a software application, a platform, a server, a client device, a computing system, and other resource or device. Specifically, this request indicates that the entity is accessing an interactive portal through an interactive platform. The assigned unique identifier may serve to distinctly identify and track this particular access session. In an example implementation, the unique identifier may be linked with two key pieces of information: the specific device being used to access the interactive portal, and the interactive platform through which the access is occurring. This linkage is crucial as it allows for more granular and context-rich tracking of user interactions. For example, if a user accesses the portal from his smartphone using a mobile browser, the unique identifier would be associated with both that smartphone and that specific mobile browser. This level of detail enables more accurate analysis of user behavior across different devices and platforms.

At block 404, an event for the interactive portal, being accessed by the entity, may be captured. The capture process is facilitated by an event tracker that is operationally linked with the interactive platform. In an example, the event tracker may be embedded in the interactive platform The operational linkage ensures that the event tracker has deep integration with the platform, allowing it to monitor and record user interactions in real-time and with high fidelity. The captured event represents a specific interaction between the entity and the interactive portal. For example, the event may encompass a wide range of actions, such as clicking a button, submitting a form, viewing a page, or any other meaningful interaction within the portal. The event tracker may identify the interactions as they occur and record them for further analysis. This real-time capture of events may help in building a comprehensive understanding of user's engagement with the interactive portal.

At block 406, the method includes recording one or more attributes for the captured event. The attributes serve as additional contextual information that provides deeper insights into the nature and circumstances of the event. The attributes include contextual data that indicates one or more aspects related to either the event itself, the interactive portal, or both. The contextual data enriches the basic event information with valuable metadata. For example, attributes may include the timestamp of when the event occurred, the specific page or section of the portal where the interaction took place, the duration of the interaction, or any relevant user input associated with the event. Additionally, technical details such as the user's browser type, screen resolution, or connection speed may also be captured as attributes. The attributes may allow for more efficient analysis of user behavior and can help to identify patterns or issues that may not be apparent from the basic event data alone.

At block 408, an entity identifier may be associated with the previously assigned unique identifier. Such association occurs when the entity registers or otherwise identifies themselves within the interactive portal. For example, the entity identifier may be an information that uniquely identifies the individual or organization interacting with the portal, such as a username, an email address, or an account number. The association of the entity identifier with the previously assigned unique identifier bridges the gap between anonymous tracking (using the unique identifier) and identified user behavior. By associating these two identifiers, the system can now connect all previous anonymous activity with a known entity. This allows for a more complete picture of the user's journey, from their first anonymous interaction to their current identified state. The association may thus enable personalized experiences, more accurate user profiling, and the ability to track long-term engagement patterns for specific entities.

At block 410, the method includes analyzing the recorded attributes and the data linked with the entity identifier to generate metrics. The metrics serve as indicators that provide meaningful insights into user behavior, engagement patterns, and the overall effectiveness of the interactive portal. The analysis process involves aggregating and processing the raw data collected from events and attributes, along with any historical data associated with the entity identifier. This might involve statistical analysis, pattern recognition, or machine learning techniques to extract meaningful insights from the data. The resulting metrics could cover a wide range of indicators, such as session duration, frequency of visits, commonly accessed features, conversion rates, or user retention rates. In an example, the metrics may provide a quantitative basis for understanding how entities interact with the portal and can inform decisions about design, functionality, and user experience improvements.

At block 412, a representation of the entity may be generated based on the metrics. The representation serves as a comprehensive profile that encapsulates the interactions and engagement patterns of the entity with the interactive portal. The representation may take various forms depending on the specific needs and context of the system. In an example, the representation may be a visual dashboard showing key metrics and trends, a detailed user profile with historical interaction data, or a set of behavioral segments that categorize users based on their engagement patterns. The representation may provide a holistic view of the entity's relationship with the interactive portal, highlighting their preferences, behaviors, and potential areas for improved engagement. The representation may be beneficial for personalization efforts, targeted marketing, and overall strategy for improving user experience and engagement within the interactive portal.

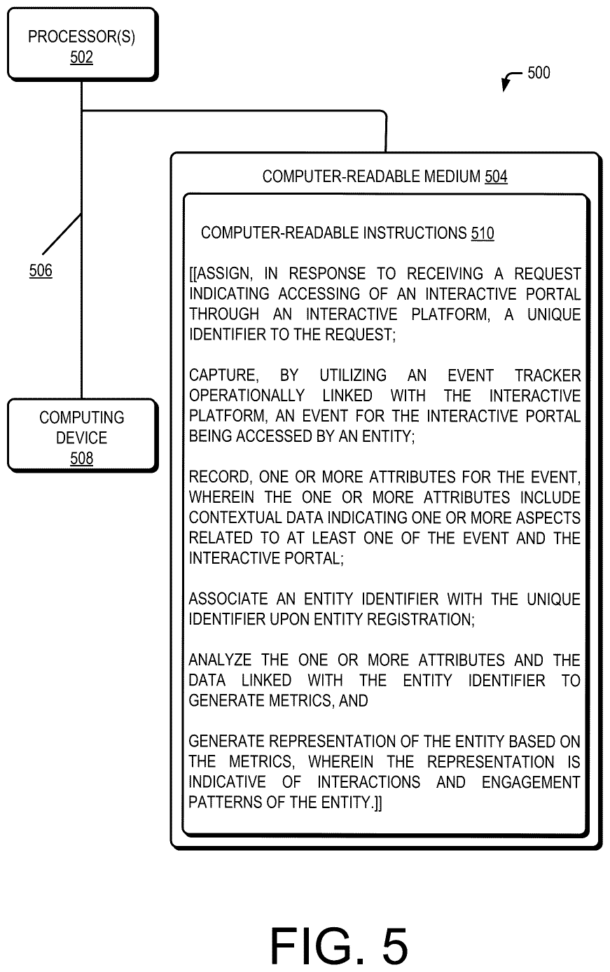

FIG. 5 illustrates a non-transitory computer-readable medium for management of entity activity, according to an example implementation of the present subject matter., in accordance with an example of the present subject matter.

In an example, the computing environment 500 comprises processor(s) 502 communicatively coupled to a non-transitory computer-readable medium 504 through communication link 506. In an example, the computing environment 500 may be, for example, the system 102, 200. In an example, the processor(s) 502 may have one or more processing resources for fetching and executing computer-readable instructions 510 from the non-transitory computer-readable medium 504. The processor(s) 502 and the non-transitory computer-readable medium 504 may be implemented, for example, in the system 102, 200.

The non-transitory computer-readable medium 504 may be, for example, an internal memory device or an external memory. In an example, the communication link 506 may be a network communication link, or other communication links, such as a PCI (Peripheral component interconnect) Express, USB-C (Universal Serial Bus Type-C) interfaces, I2C (Inter-Integrated Circuit) interfaces, etc. In an example, the non-transitory computer-readable medium 504 comprises a set of computer-readable instructions 510 which may be accessed by the processor(s) 502 through the communication link 506 and subsequently executed for facilitating optimization of cellular network performance of the network element. The processor(s) 502 and the non-transitory computer-readable medium 504 may also be communicatively coupled to a system 102, 200 over the network. The processor(s) 502 and the non-transitory computer-readable medium 504 may also be communicatively coupled to a computing device 508 through the communication link 506.

Referring to FIG. 5, in an example, the non-transitory computer-readable medium 504 comprises computer-readable instructions 510 that cause the processor(s) 502 to assign, in response to receiving a request indicating accessing of an interactive portal through an interactive platform, a unique identifier to the request. The unique identifier is linked with a device and the interactive platform accessing the interactive portal.

In an example, the computer-readable instructions 510 may then cause the processor(s) 502 to capture, by utilizing an event tracker operationally linked with the interactive platform, an event for the interactive portal being accessed by an entity. The event indicates occurrence of an interaction of the entity with the interactive portal. The computer-readable instructions 510 may then cause the processor(s) 502 to record one or more attributes for the event. The one or more attributes may include contextual data indicating one or more aspects related to at least one of the event and the interactive portal.

In an example, the computer-readable instructions 510 may then cause the processor(s) 502 to associate an entity identifier with the unique identifier upon entity registration and to analyze the one or more attributes and the data linked with the entity identifier to generate metrics. In an example, the computer-readable instructions 510 may then cause the processor(s) 502 to generate representation of the entity based on the metrics, wherein the representation is indicative of interactions and engagement patterns of the entity.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
assign, in response to receiving a request indicating accessing of an interactive portal through an interactive platform, a unique identifier to the request, wherein the unique identifier is linked with a device and the interactive platform accessing the interactive portal;
capture, by utilizing an event tracker operationally linked with the interactive platform, an event for the interactive portal being accessed by an entity, wherein the event indicates occurrence of an interaction of the entity with the interactive portal;
record, one or more attributes for the event, wherein the one or more attributes include contextual data indicating one or more aspects related to at least one of the event and the interactive portal;
associate an entity identifier with the unique identifier upon entity registration;
analyze the one or more attributes and the data linked with the entity identifier to generate metrics, and
generate representation of the entity based on the metrics, wherein the representation is indicative of interactions and engagement patterns of the entity.

2. The system of claim 1, wherein the processor is to:
track activity of the entity across a plurality of devices by associating multiple unique identifiers with the same user identifier upon entity registration from the plurality of devices; and
generate a consolidated representation of the entity's interactions across the plurality of devices.

3. The system of claim 1, wherein the one or more attributes comprises a resource identifier accessed by the entity, a source identifier, and a network identifier of the entity.

4. The system of claim 3, wherein the resource identifier comprises a Uniform Resource Locator (URL) of the interactive portal accessed by the entity, wherein the source identifier is indicative of the origin of the entity's access, and wherein the network identifier of the entity comprises an Internet Protocol (IP) address associated with the entity's device during the interaction with the interactive platform.

5. The system of claim 1, wherein the metrics include one or more of session analytics, user behavior analytics, and organizational analytics, wherein the session analytics is indicative of individual user sessions, wherein the user behavior analytics is indicative of aggregated data across multiple sessions for each unique entity, and wherein the organizational analytics is indicative of entities representing an organization.

6. The system of claim 5, wherein the processor is to:
determine a new session initiation after a predefined period of entity inactivity, and
generate the session analytics including session duration, number of interactive portal accessed, and time spent on each interactive portal within the session.

7. The system of claim 5, wherein the processor is to:
extract an organizational domain from the organizational analytics based on entity identifiers, and
aggregate metrics at an organizational level, wherein the aggregate metrics include one or more of total number of entities, cumulative time spent, total number of visits, first visit timestamp, and most recent visit timestamp for all entities associated with the same organizational domain.

8. The system of claim 1, wherein the processor is to:
perform retroactive deanonymization by associating previously recorded anonymous activities with the entity identifier upon entity registration; and
determine a complete historical entity journey based on the performed retroactive deanonymization.

9. A method comprising:
assigning, in response to receiving a request indicating accessing of an interactive portal through an interactive platform, a unique identifier to the request, wherein the unique identifier is linked with a device and the interactive platform accessing the interactive portal;
capturing, by utilizing an event tracker operationally linked with the interactive platform, an event for the interactive portal being accessed by an entity, wherein the event indicates occurrence of an interaction of the entity with the interactive portal;
recording, one or more attributes for the event, wherein the one or more attributes include contextual data indicating one or more aspects related to at least one of the event and the interactive portal;
associating an entity identifier with the unique identifier upon entity registration;
analyzing the one or more attributes and the data linked with the entity identifier to generate metrics; and
generating representation of the entity based on the metrics, wherein the representation is indicative of interactions and engagement patterns of the entity.

10. The method of claim 9, wherein the one or more attributes comprises a resource identifier accessed by the entity, a source identifier, and a network identifier of the entity.

11. The method of claim 10, wherein the resource identifier comprises a Uniform Resource Locator (URL) of the interactive portal accessed by the entity, wherein the source identifier is indicative of the origin of the entity's access, and wherein the network identifier of the entity comprises an Internet Protocol (IP) address associated with the entity's device during the interaction with the interactive platform.

12. The method of claim 9, wherein the metrics include one or more of session analytics, user behavior analytics, and organizational analytics, wherein the session analytics is indicative of individual user sessions, wherein the user behavior analytics is indicative of aggregated data across multiple sessions for each unique entity, and wherein the organizational analytics is indicative of entities representing an organization.

13. The method of claim 12, the method comprising:
determining a new session initiation after a predefined period of entity inactivity, and
generating the session analytics including session duration, number of interactive portal accessed, and time spent on each interactive portal within the session.

14. The method of claim 12, the method comprising:
extracting an organizational domain from the organizational analytics based on entity identifiers, and
aggregating metrics at an organizational level, wherein the aggregate metrics include one or more of total number of entities, cumulative time spent, total number of visits, first visit timestamp, and most recent visit timestamp for all entities associated with the same organizational domain.

15. The method of claim 9, the method comprising:
performing retroactive deanonymization by associating previously recorded anonymous activities with the entity identifier upon entity registration; and
determining a complete historical entity journey based on the performed retroactive deanonymization.

16. A non-transitory computer-readable medium comprising instructions, the instructions being executable by a processor to:
assign, in response to receiving a request indicating accessing of an interactive portal through an interactive platform, a unique identifier to the request, wherein the unique identifier is linked with a device and the interactive platform accessing the interactive portal;
capture, by utilizing an event tracker operationally linked with the interactive platform, an event for the interactive portal being accessed by an entity, wherein the event indicates occurrence of an interaction of the entity with the interactive portal;
record, one or more attributes for the event, wherein the one or more attributes include contextual data indicating one or more aspects related to at least one of the event and the interactive portal;
associate an entity identifier with the unique identifier upon entity registration;
analyze the one or more attributes and the data linked with the entity identifier to generate metrics, and
generate representation of the entity based on the metrics, wherein the representation is indicative of interactions and engagement patterns of the entity.

17. The non-transitory computer-readable medium of claim 16, the instructions being executable by the processor to:
track activity of the entity across a plurality of devices by associating multiple unique identifiers with the same user identifier upon entity registration from the plurality of devices; and
generate a consolidated representation of the entity's interactions across the plurality of devices.

18. The non-transitory computer-readable medium of claim 16, the instructions being executable by the processor to:
determine a new session initiation after a predefined period of entity inactivity, and
generate session analytics including session duration, number of interactive portal accessed, and time spent on each interactive portal within the session.

19. The non-transitory computer-readable medium of claim 16, the instructions being executable by the processor to:
extract an organizational domain from the organizational analytics based on entity identifiers, and
aggregate metrics at an organizational level, wherein the aggregate metrics include one or more of total number of entities, cumulative time spent, total number of visits, first visit timestamp, and most recent visit timestamp for all entities associated with the same organizational domain.

20. The non-transitory computer-readable medium of claim 16, the instructions being executable by the processor to:
perform retroactive deanonymization by associating previously recorded anonymous activities with the entity identifier upon entity registration; and
determine a complete historical entity journey based on the performed retroactive deanonymization.
